(19) United States
(12) Patent Application Publication
(10) Pub. No.: US 2026/0285128 A1
(43) Pub. Date: Sep. 24, 2026

(54) Pressure Relief Valve Assembly

(71) Applicant: Illinois Tool Works Inc., Glenview, IL (US)

(72) Inventors: Yuhang Zeng, Shanghai (CN); Jing Cheng, Shanghai (CN); Jian Wang, Shanghai (CN); Guofeng Yue, Shanghai (CN); Qihong Teng, Shanghai (CN)

(21) Appl. No.: 19/569,619

(22) Filed: Mar. 17, 2026

(30) Foreign Application Priority Data
Mar. 19, 2025 (CN) 2025103256450
Mar. 11, 2026 (CN) 2026102963069
Mar. 11, 2026 (CN) 2026202996119

(51) Int. Cl. B60H 1/24

(52) U.S. Cl. CPC B60H 1/249

(57) ABSTRACT

A pressure relief valve assembly includes a frame defining a ventilation port, a valve flap attached to the frame to open and close the port, a cover with a cover opening, a valve core rotatably arranged relative to the cover and having a valve plate, and a driving device coupled to the valve core. The driving device rotates the valve core between a fully closed position, in which the valve plate completely closes the cover opening, and a fully open position, in which the valve plate fully opens the cover opening. The valve core and motorized rotation provide complete sealing of the pressure relief valve, enhancing waterproof, dustproof, and smoke-proof performance.

### RELATED APPLICATIONS

The present application claims the benefit of Chinese Patent Application Nos. 202510325645.0, filed Mar. 19, 2025, 202610296306.9, filed Mar. 11, 2026, and 202620299611.9, filed Mar. 11, 2026, each titled “Pressure Relief Valve Assembly,” the contents of which are hereby incorporated by reference.

### BACKGROUND

With the continuous advancement of vehicle design and technology, the cabin of a modern vehicle is typically a relatively sealed space. Due to limited air circulation within the cabin, pressure fluctuations may occur during vehicle operation as a result of changes in the external environment or variations in temperature, humidity and other factors inside the cabin. In order to ensure that the pressure inside the cabin remains within a reasonable range and to avoid adverse effects on the cabin structure, equipment or passengers, vehicles are typically provided with ventilation openings and pressure relief valves so as to effectively control the pressure within the cabin. The pressure relief valve can open or close when the pressure inside the cabin becomes excessively high or low, thereby adjusting the opening state of the ventilation opening and achieving a balance of the pressure difference between the inside and outside of the cabin.

### SUMMARY OF THE DISCLOSURE

The present disclosure relates generally to a pressure relief valve assembly, substantially as illustrated by and described in connection with at least one of the figures, as set forth more completely in the claims. More particularly, the present disclosure relates generally to vehicle components, and even more particularly to a pressure relief valve assembly for releasing internal air pressure of a vehicle.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 is a schematic diagram of a vehicle having the pressure relief valve assembly of the present application.

FIG. 2A is a schematic diagram showing the pressure relief valve assembly of the present application in a fully open state.

FIG. 2B is a schematic diagram showing the pressure relief valve assembly of the present application in a fully closed state.

FIG. 3A is a perspective view of the pressure relief valve assembly of the present application.

FIG. 3B is a perspective view of the pressure relief valve assembly of the present application from another angle.

FIG. 3C is an exploded view of the pressure relief valve assembly of the present application.

FIG. 4A is a perspective view of the cover of the pressure relief valve assembly.

FIG. 4B is a perspective view of the seat of the pressure relief valve assembly.

FIG. 4C is a perspective view of the valve core of the pressure relief valve assembly.

FIG. 4D is a perspective view of the frame of the pressure relief valve assembly.

FIG. 4E is a perspective view of the frame of the pressure relief valve assembly from another angle.

FIG. 5 is a schematic diagram showing a control mode of the pressure relief valve assembly of the present application.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples, and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

With increasing requirements for vehicle quality, consumers have higher expectations particularly for electric vehicles in terms of noise, vibration and harshness (NVH), waterproof performance (including vehicle wading capability), and reduction of smoke and dust intrusion. Through long-term observation and research, the inventors of the present application have found that, as a part of a vehicle ventilation system, a pressure relief valve used for releasing internal air pressure of a vehicle not only maintains the pressure balance between the interior and exterior of the vehicle, but also plays an important role in reducing the entry of external dust, smoke, water and noise. Therefore, the pressure relief valve needs to meet both the requirements of pressure release and sealing, and also needs to improve performance in aspects such as automatic control accuracy, response speed and adaptability to different environmental changes, so as to meet more complex and efficient vehicle pressure regulation and sealing requirements. In addition, as the number of electronic components in vehicles, particularly electric vehicles, continues to increase, a pressure relief valve having a more compact structure is required so as to reduce the installation space required on the exterior of the vehicle body.

Existing cabin pressure relief valves generally use flexible rubber sheets as sealing elements. When the internal cabin pressure exceeds the external pressure by a certain value, the rubber sheet opens and closes through its own weight, rotation or bending. Such pressure relief valves typically include a flexible rubber sheet and a plastic skeleton frame. The rubber sheet is connected to the skeleton frame, and an opening is provided at the center of the skeleton frame. When the pressure difference between the inside and outside of the cabin exceeds a certain value, the rubber sheet opens outward under the action of the pressure difference, thereby releasing the cabin pressure through the opening of the skeleton frame. When the pressure inside and outside the cabin becomes balanced again, the rubber sheet returns to its original position under the action of its own gravity, closing against the skeleton frame and covering the opening of the skeleton frame so as to prevent external gas, rainwater, smoke, dust and noise from entering the cabin.

In addition, in order to meet vehicle sealing requirements, the prior art introduces a combination of a linear motor and a sealing cover into conventional pressure relief valves so as to realize opening and closing of the pressure relief valve. For example, when a vehicle travels through water, the sealing cover is driven by the linear motor to cover the ventilation opening of the pressure relief valve so as to completely seal the ventilation opening, thereby preventing water from entering the cabin through the pressure relief valve. When the vehicle does not need to travel through water, the linear motor drives the sealing cover away from the ventilation opening of the pressure relief valve so that the pressure relief valve can perform normal ventilation and pressure relief functions.

However, the above pressure relief valves have certain problems. First, since the flexible rubber sheet may open unintentionally due to pressure fluctuations or wind forces during vehicle driving, which may cause external rainwater, smoke, dust and noise to enter the cabin, thereby contaminating internal components of the cabin and reducing the comfort of the vehicle interior. Second, the structure in which a linear motor and a sealing cover are added to the pressure relief valve may result in problems such as insufficiently fast sealing response, high performance requirements for the linear motor, and large installation space requirements due to the working principle and structural characteristics of the linear motor.

In order to solve the above technical problems, according to a first aspect of the present application, a pressure relief valve assembly is provided, comprising: a frame defining a ventilation opening; a valve flap attached to the frame for opening and closing the ventilation opening; a cover covering the frame and provided with a cover opening; a valve core rotatably arranged relative to the cover and having a valve plate; and a driving device coupled to the valve core and configured to drive the valve core to rotate between a fully closed position, in which the cover opening is completely closed by the valve plate, and a fully open position, in which the cover opening is completely opened by the valve plate.

In some embodiments, the valve plate is connected to the frame and rotates together with the frame.

In some embodiments, the pressure relief valve assembly further comprises a seat, the cover being detachably connected to the seat and jointly defining a cavity with the seat for receiving the valve plate and the frame, wherein the seat is provided with a seat opening in connection with the ventilation opening.

In some embodiments, the frame, the cover, the valve plate and the seat have circular outer peripheral contours and are arranged coaxially.

In some embodiments, the cover comprises a cover top wall, the cover top wall being provided with a plurality of cover openings, the plurality of cover openings being arranged around the center of the cover top wall at intervals and each being substantially sector-shaped.

In some embodiments, the cover further comprises a cover side wall provided on one side of the cover top wall, and the cover is connected to the seat through the cover side wall.

In some embodiments, the valve plate is provided with a plurality of blocking portions and a plurality of valve plate openings, the plurality of blocking portions and the plurality of valve plate openings being arranged around the center of the valve plate at intervals and each being substantially sector-shaped, wherein the plurality of blocking portions are configured to respectively close the plurality of cover openings, and the plurality of valve plate openings are configured to respectively connect the plurality of cover openings with the ventilation opening.

In some embodiments, the valve core further comprises a valve core side wall provided on one side of the valve plate, and the valve core is connected to the frame through the valve core side wall.

In some embodiments, the valve core further comprises a rod portion passing through the seat and connecting the valve plate to an output end of the driving device.

According to a second aspect of the present application, a vehicle is provided, comprising the pressure relief valve assembly described above.

The present application introduces a valve core structure into a conventional vehicle pressure relief valve. The driving device drives the valve core to rotate, thereby completely sealing the cover openings on the pressure relief valve cover by means of the valve core, thus solving the problem of insufficient sealing performance of the pressure relief valve when the vehicle travels through water. In addition, the driving device adopted in the present application drives the valve core through rotational motion. Compared with linear driving structures such as linear motors, this structure provides higher response sensitivity, better sealing performance, and lower installation space requirements.

Additional aspects and advantages of the present application will be set forth in part in the following description, and in part will become apparent from the following description, or may be learned through practice of the present application.

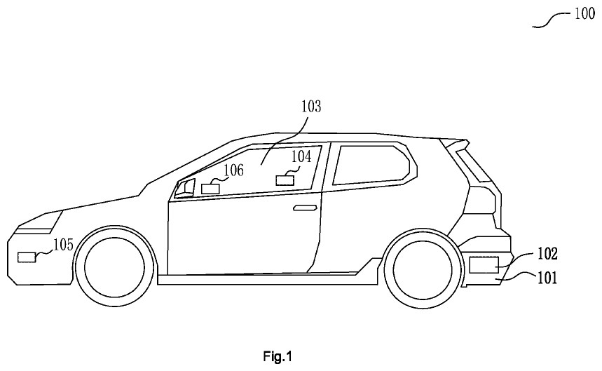

FIG. 1 is a schematic diagram of a vehicle 100 having the pressure relief valve assembly 102 of the present application.

As shown in FIG. 1, the vehicle 100 includes a cabin 103 and a pressure relief valve assembly 102 for balancing the air pressure inside and outside the cabin 103. The pressure relief valve assembly 102 is generally a non-visible component of the vehicle and is mounted on sheet metal 101 at the rear bottom of the vehicle 100, for example on the sheet metal inside the rear bumper of the vehicle. The vehicle 100 may further be provided with several sensors for collecting vehicle parameters. For example, a pressure sensor 104 is used to collect air pressure parameters inside the cabin 103, and a liquid level sensor 105 is used to collect vehicle liquid level information (wading information). Those skilled in the art will understand that other types of sensors may also be arranged in the vehicle according to specific requirements so as to collect other vehicle parameters. The pressure relief valve assembly 102 may be controlled to open and close and adjust its opening degree based on parameters or signals collected by the above sensors through a controller arranged inside or outside the pressure relief valve assembly 102. In addition, the vehicle 100 further includes a user control terminal 106 for collecting various control information input by a user. The user may directly control opening, closing or the opening degree of the pressure relief valve assembly 102 through the user control terminal 106. For example, in rainy or snowy weather, before the vehicle travels through water, or in smoggy or dusty conditions, the user may reduce the opening degree of the pressure relief valve assembly 102 or close the pressure relief valve assembly 102 with one click through the user control terminal 106, so that external water, smoke or dust cannot enter the cabin 103 through the pressure relief valve assembly 102.

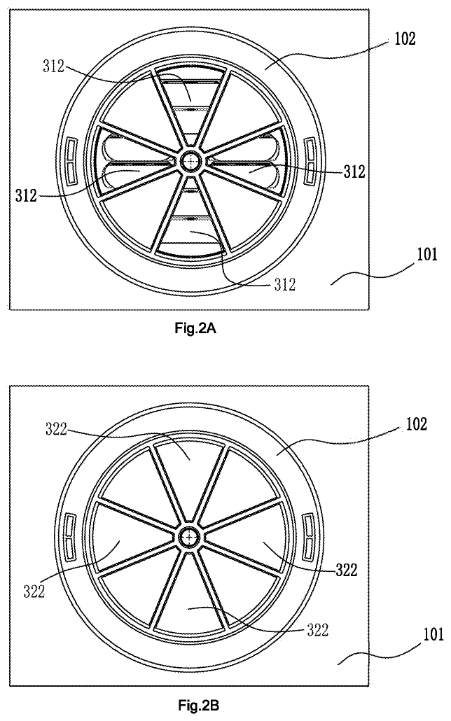

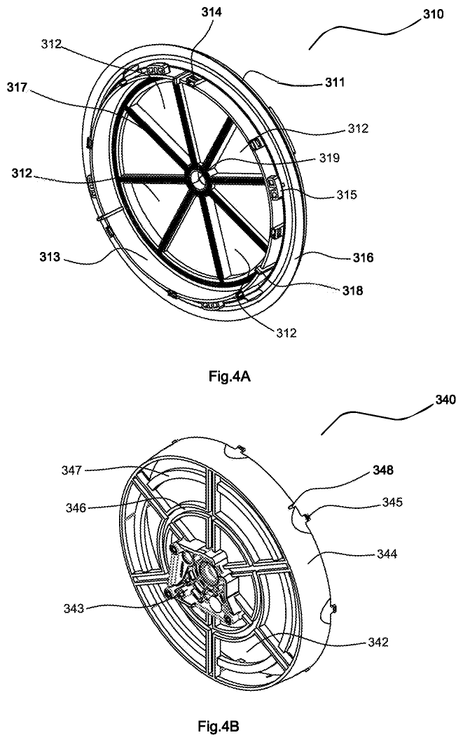

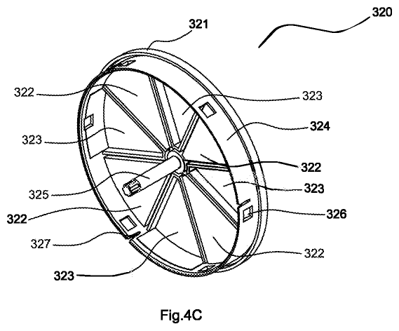

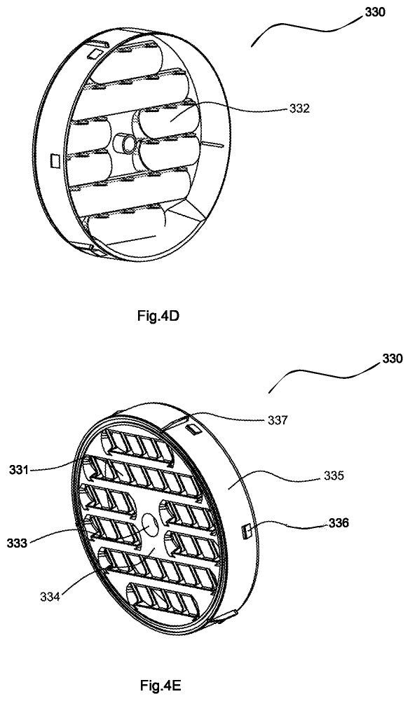

FIGS. 2A and 2B illustrate the working principle of the pressure relief valve assembly 102 of the present application. FIG. 2A is a schematic diagram showing the pressure relief valve assembly 102 in a fully open state, and FIG. 2B is a schematic diagram showing the pressure relief valve assembly 102 in a fully closed state. In the fully open state shown in FIG. 2A, the pressure relief valve assembly 102 can completely open the cover openings 312 through the valve plate openings 323 (as shown in FIG. 4C) of the valve plate 321, thereby allowing the cabin of the vehicle to communicate with the external environment so as to release the pressure inside the cabin. In the fully closed state shown in FIG. 2B, the pressure relief valve assembly 102 can completely close the cover openings 312 through the blocking portions 322 (as shown in FIG. 4C) of the valve plate 321, thereby isolating the vehicle cabin from the external environment. As shown in FIGS. 2A and 2B, the pressure relief valve assembly 102 is mounted on the vehicle sheet metal 101.

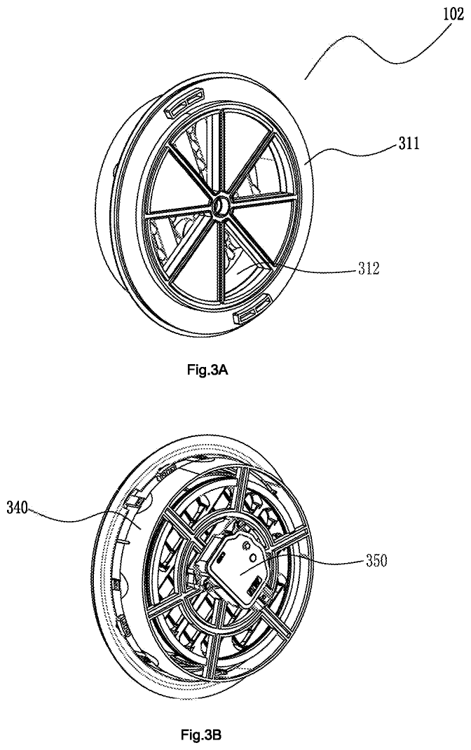

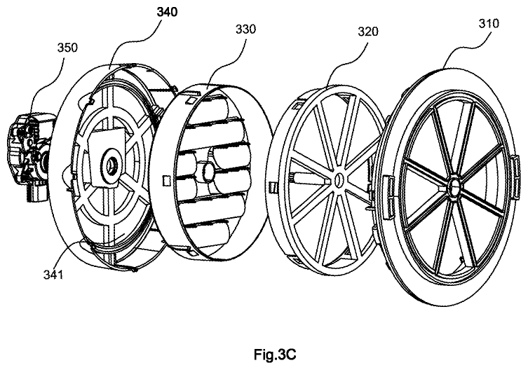

FIG. 3A is a perspective view of the pressure relief valve assembly 102 of the present application, FIG. 3B is a perspective view of the pressure relief valve assembly 102 from another angle, and FIG. 3C is an exploded view of the pressure relief valve assembly 102 so as to show more internal components of the pressure relief valve assembly 102.

As shown in FIGS. 3A and 3B, the pressure relief valve assembly 102 includes a cover 310, a seat 340, and a driving device 350 mounted on the seat 340. The cover 310 includes a cover top wall 311 provided with a plurality of cover openings 312. The plurality of cover openings 312 are arranged at intervals around the center of the cover top wall 311, and each of the cover openings 312 is substantially sector-shaped. As shown in FIG. 3C, in one embodiment of the present application, the pressure relief valve assembly 102 further includes a valve core 320 and a frame 330 disposed between the cover 310 and the seat 340. The frame 330, the cover 310, the valve plate 321 (see FIG. 4C), and the seat 340 have circular outer peripheral contours and are arranged coaxially. Those skilled in the art will understand that, depending on specific design requirements, the pressure relief valve assembly 102 of the present application may include other components in addition to those described above, or may include only part of the above components, as long as the functional requirements can be satisfied. For example, a filter screen may be added on the outside of the cover 310 so as to filter external leaves or stones, improve waterproof performance, and reduce NVH. In addition, a sound-insulating cover may be added on the outside of the seat 340 so as to improve the NVH performance of the vehicle. The above components will be described in detail below with reference to FIGS. 4A-4E.

FIG. 4A is a perspective view of the cover 310 of the pressure relief valve assembly 102. FIG. 4B is a perspective view of the seat 340 of the pressure relief valve assembly 102. FIG. 4C is a perspective view of the valve core 320 of the pressure relief valve assembly 102. FIG. 4D is a perspective view of the frame 330 of the pressure relief valve assembly 102. FIG. 4E is a perspective view of the frame 330 of the pressure relief valve assembly 102 from another angle.

FIG. 4A is a perspective view of the cover 310 of the pressure relief valve assembly 102. As shown in FIG. 4A, in one embodiment of the present application, the cover 310 includes a cover top wall 311 and a cover side wall 313 extending from one side of the cover top wall 311. In one embodiment of the present application, a cylindrical connecting portion 319 is provided at the center of the cover top wall 311. Eight reinforcing ribs are evenly distributed around the side wall of the cylindrical connecting portion 319 and extend radially toward the inner side of the cover top wall 311, thereby forming eight substantially identical 45° sector-shaped spaces. Among the eight sector-shaped spaces, four are cover openings 312, and the four cover openings 312 are arranged at intervals. Grooves are formed on the eight reinforcing ribs, the cylindrical connecting portion 319, and the inner side of the cover top wall 311 for mounting a gasket 317. The gasket 317 is used to abut against the surface of the valve core 320 so as to provide reliable sealing performance while reducing friction. A plurality of cover snap-fit grooves 314, cover mounting portions 315, and cover positioning portions 318 are provided on the cover side wall 313 at intervals. The cover positioning portions 318 are used for positioning engagement with corresponding structures on the seat 340. The cover snap-fit grooves 314 are used for cooperating with plug-in portions provided on the seat 340 so that the cover 310 and the seat 340 can be detachably assembled together. As shown in FIG. 4A, the cover side wall 313 is sleeved with the cover mounting portions 315. When the pressure relief valve assembly 102 is mounted on the vehicle sheet metal 101, the cover mounting portions 315 first pass through corresponding openings in the sheet metal 101. The pressure relief valve assembly 102 is then rotated so that the cover mounting portions 315 abut against the inner surface of the sheet metal 101 and cannot rotate out automatically, thereby firmly fixing the pressure relief valve assembly 102 to the vehicle. A sealing ring 316 is sleeved on the cover top wall 311. When the pressure relief valve assembly 102 is mounted on the sheet metal 101 of the vehicle, the sealing ring 316 abuts against the outer surface of the sheet metal 101 so that the pressure relief valve assembly 102 is sealed relative to the sheet metal 101 while also adjusting the assembly clearance therebetween. Except for the gasket 317 and the sealing ring 316 mounted on the cover 310, the other structures of the cover 310 are integrally formed. Those skilled in the art will understand that the cover 310 and the seat 340 may also be fixed together by other connection structures. Moreover, the cover openings 312 on the cover 310 are not limited to the four spaced sector-shaped openings described above, and may be designed in different shapes according to specific requirements as long as the functional requirements are satisfied.

FIG. 4B is a perspective view of the seat 340 of the pressure relief valve assembly 102 of the present application. As shown in FIG. 4B, in one embodiment of the present application, the seat 340 includes an annular seat side wall 344. The seat side wall 344 and the cover 310 jointly define a cavity 341 for receiving the valve plate 321 as shown in the following FIG. 4C and the frame 330as shown in the following FIG. 4D-4E. Similar to the reinforcing rib structure on the cover 310 described above, the bottom end of the seat side wall 344 includes six reinforcing ribs extending radially from the center toward the inner side of the side wall. In addition, a first annular reinforcing rib 346 and a second annular reinforcing rib 347 having different diameters are provided on the bottom end of the seat side wall 344. An installation base 343 is provided at the center of the bottom end of the seat side wall 344 for mounting the driving device 350 shown in FIG. 3C onto the seat 340. The second annular reinforcing rib 347 is provided with a mounting groove on the side facing the cover 310 for installing a corresponding support ring (not shown). The support ring is used to adjust the rotational friction between the seat 340 and the frame 330 and to adjust the friction and sealing performance between the valve core 320 and the gasket 317 on the cover 310. Those skilled in the art should understand that the seat 340 may not be provided with a mounting groove for mounting the support ring, or the mounting groove may be provided at other positions on the seat 340, as long as the rotational friction force between the seat 340 and the frame 330 and the friction force and sealing performance at the gasket 317 on the valve core 320 and the cover 310 satisfy the specific functional requirements. The six reinforcing ribs and the two annular reinforcing ribs divide the seat 340 into several seat openings 342. These seat openings 342 communicate with the cover openings 312 in FIG. 4A and the ventilation openings 331 on the frame 330 (see FIG. 4E), thereby allowing the vehicle cabin to communicate with the external air so as to balance the pressure inside the cabin. As shown in FIG. 4B, the seat side wall 344 is provided with a plurality of seat plug-in portions 345 and seat positioning grooves 348 around its top end. The seat positioning grooves 348 are used to receive the cover positioning portions 318 on the cover 310, and the seat plug-in portions 345 are used to insert into the cover snap-fit grooves 314 on the cover 310 so that the cover 310 and the seat 340 are assembled together. The seat 340 is integrally formed. Those skilled in the art should understand that the cover 310 and the seat 340 may also be fixed together through other connecting structures, and the reinforcing ribs on the seat 340 may be designed in different shapes according to specific requirements, as long as the specific functional requirements can be satisfied. In addition, the seat 340 of the pressure relief valve assembly 102 of the present application may include other components in addition to the above components, or may include only a part of the above components, as long as the specific functional requirements can be satisfied.

FIG. 4C is a perspective view of the valve core 320 of the pressure relief valve assembly 102. As shown in FIG. 4C, in one embodiment of the present application, the valve core 320 includes a valve plate 321 and a valve core side wall 324 located on one side of the valve plate 321. The valve core side wall 324 is provided with a plurality of mounting holes 326 and valve core snap-fit grooves 327 which are evenly distributed along the valve core side wall 324 for cooperating with corresponding structures on the frame 330 as shown in FIG. 4D, so that the valve core 320 and the frame 330 can be assembled together. Similar to the reinforcing rib structure on the cover 310, the valve plate 321 includes eight reinforcing ribs extending radially from the inner side of the valve core side wall 324 toward the annular center, so as to form eight substantially identical 45° sector-shaped spaces. Among the eight sector-shaped spaces, four are blocking portions 322 and the other four are valve plate openings 323, and the blocking portions 322 and the valve plate openings 323 are arranged alternately. It should be noted that the eight sector-shaped spaces on the valve plate 321 have substantially the same size as the eight sector-shaped spaces on the cover 310 as shown in FIG. 4A, so that the four blocking portions 322 on the valve plate 321 can respectively cover the four cover openings 312 on the cover 310. As shown in FIG. 4C, a rod portion 325 extends axially from the annular center toward the seat 340. The free end of the rod portion 325 is provided with a toothed structure for meshing with a driving gear in the output end of the driving device 350 so as to drive the valve core 320 to rotate. For example, when the four blocking portions 322 on the valve core 320 are located outside the four sector-shaped cover openings 312 of the cover 310, the four valve plate openings 323 coincide with the four cover openings 312, and the opening degree of the pressure relief valve assembly 102 is at its maximum. At this time, air can pass smoothly through the pressure relief valve assembly so as to balance the air pressure inside and outside the vehicle. When the valve core 320 rotates such that the four blocking portions 322 respectively cover the four cover openings 312 of the cover 310, the cover 310 of the pressure relief valve assembly 102 is completely sealed. At this time, the opening degree of the pressure relief valve assembly 102 is at its minimum, thereby preventing external water from entering the cabin through the pressure relief valve when the vehicle travels through water, or preventing external smoke, dust or other foreign matter from entering the cabin. The opening degree of the pressure relief valve assembly 102 can be controlled by rotating the valve core 320 so as to achieve any opening degree between the maximum opening degree and the minimum opening degree, thereby satisfying both pressure relief requirements and sealing performance requirements of the vehicle.

FIG. 4D is a perspective view of the frame 330 of the pressure relief valve assembly 102. FIG. 4E is a perspective view of the frame 330 of the pressure relief valve assembly 102 from another angle. As shown in FIGS. 4D and 4E, in one embodiment of the present application, the frame 330 includes a frame base 334 and an annular frame side wall 335 extending from the frame base 334. The frame side wall 335 is provided with a plurality of frame snap-fit protrusions 336 and frame positioning portions 337 distributed along the frame side wall 335 for cooperating with the mounting holes 326 and the valve core snap-fit grooves 327 on the valve core 320, so that the frame 330 and the valve core 320 can be assembled together. A circular through hole 333 is formed at the center of the frame base 334 for allowing the rod portion 325 of the valve core 320 to pass through. A plurality of ventilation openings 331 are further provided on the frame base 334. A plurality of valve flaps 332 (for example flexible rubber sheets) are mounted on the side of the frame base 334 facing the valve core 320, so as to respectively cover the ventilation openings 331. When the air pressure inside the cabin becomes excessive, air can be discharged to the outside of the vehicle through the ventilation openings 331. In addition, a noise-reducing nonwoven fabric structure may be provided on the frame 330 so as to reduce noise generated when the valve flaps 332 strike the frame 330. When the valve core 320 and the frame 330 are assembled together, they are fixed relative to each other so that the frame 330 rotates together with the valve core 320. Those skilled in the art will understand that the valve core 320 and the frame 330 may also be fixed together by other connection structures, and the shape and number of ventilation openings on the frame 330 may be designed according to specific requirements.

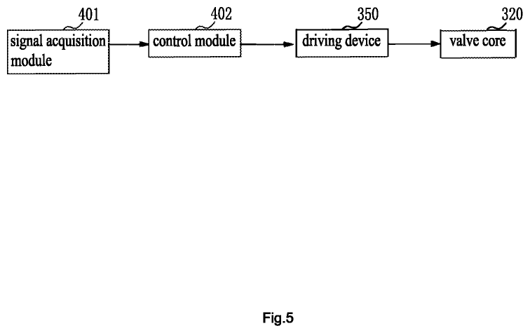

FIG. 5 is a schematic diagram showing the control mode of the pressure relief valve assembly of the present application.

As shown in FIG. 5, a signal acquisition module 401 is connected to a control module 402 and transmits collected signals to the control module 402. The signals collected by the signal acquisition module 401 may include: cabin pressure signals collected by the pressure sensor 104 shown in FIG. 1, vehicle liquid level signals collected by the liquid level sensor 105, vehicle door opening signals, vehicle air conditioner switch signals, and air conditioning airflow signals collected from other sensors, and user input signals. The control module 402 receives the signals from the signal acquisition module 401 and processes the signals, and then outputs control signals to the driving device 350. The output end of the driving device 350 drives the rod portion 325 of the valve core 320, so that the valve core 320 rotates, thereby realizing opening, closing and adjustment of the opening degree of the cover openings 312 on the cover 310 by the valve plate 321 of the valve core 320.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### Reference Numerals List

100 Vehicle
101 Sheet metal
102 Pressure relief valve assembly
103 Vehicle cabin
104 Pressure sensor
105 Liquid level sensor
310 Cover
311 Cover top wall
312 Cover opening
313 Cover side wall
314 Cover snap-fit groove
315 Cover mounting portion
316 Sealing ring
317 Gasket
318 Cover positioning portion
319 Cylindrical connecting portion
320 Valve core
321 Valve plate
322 Blocking portion
324 Valve core side wall
325 Rod portion
326 Mounting hole
327 Valve core snap-fit groove
330 Frame
331 Ventilation port
332 Valve flaps
333 Circular through hole
334 Frame base
335 Frame side wall
336 Frame snap-fit protrusion
337 Frame positioning portion
340 Seat
343 Mounting base
344 Seat side wall
345 Seat plug-in portion
346 First annular reinforcing rib
347 Second annular reinforcing rib
348 Seat positioning groove
350 Driving device
401 Signal acquisition module
402 Control module

What is claimed is:

1. A pressure relief valve assembly, comprising:
a frame defining a ventilation port;
a valve flap attached to the frame to open and close the ventilation port;
a cover covering the frame and provided with a cover opening;
a valve core rotatably arranged relative to the cover and having a valve plate; and
a driving device coupled to the valve core and configured to drive the valve core to rotate between a fully closed position in which the cover opening is completely closed by the valve plate and a fully opened position in which the cover opening is completely opened by the valve plate.

2. The pressure relief valve assembly according to claim 1, wherein the valve plate is connected to the frame and rotates together with the frame.

3. The pressure relief valve assembly according to claim 2, further comprising:
a base, the cover being detachably connected to the base and jointly defining a cavity with the base to receive the valve plate and the frame;
wherein the base is provided with a base opening, and the base opening is in connection with the ventilation port.

4. The pressure relief valve assembly according to claim 3, wherein the frame, the cover, the valve plate, and the base have circular outer peripheral contours and are coaxially arranged.

5. The pressure relief valve assembly according to claim 4, wherein the cover comprises a cover top wall, and the cover top wall is provided with a plurality of the cover openings, the plurality of cover openings being spaced apart around the center of the cover top wall and each substantially fan-shaped.

6. The pressure relief valve assembly according to claim 5, wherein the cover further comprises a cover side wall provided on one side of the cover top wall, the cover being connected to the base through the cover side wall.

7. The pressure relief valve assembly according to claim 5, wherein the valve plate is provided with a plurality of blocking portions and a plurality of valve plate openings, the plurality of blocking portions and the plurality of valve plate openings being spaced apart around the center of the valve plate and each substantially sector-shaped; and
wherein the plurality of blocking portions are configured to close the plurality of cover openings respectively, and the plurality of valve plate openings are configured to connect the plurality of cover openings with the ventilation port respectively.

8. The pressure relief valve assembly according to claim 7, wherein the valve core further comprises a valve core side wall provided on one side of the valve plate, the valve core being connected to the frame through the valve core side wall.

9. The pressure relief valve assembly according to claim 7, wherein the valve core further comprises a rod portion, the rod portion passing through the base to connect the valve plate to an output end of the driving device.

10. A vehicle comprising the pressure relief valve assembly according to claim 1.
